(19) United States
(12) Patent Application Publication
(10) Pub. No.: US 2026/0342097 A1
(43) Pub. Date: Oct. 29, 2026

(54) SYSTEM AND METHOD FOR GENERATION AND ALLOCATION OF ENERGY UNITS

(71) Applicant: Singularity Energy, Inc., Somerville, MA (US)

(72) Inventors: Wenbo Shi, Wellesley, MA (US); Paul A. Dixon, Vashon, WA (US)

(21) Appl. No.: 19/650,937

(22) Filed: Apr. 17, 2026

Related U.S. Application Data
(60) Provisional application No. 63/794,282, filed on Apr. 24, 2025.

(51) Int. Cl. H02J 3/38; H02J 13/12

(52) U.S. Cl. CPC H02J 3/38; H02J 13/12

(57) ABSTRACT

The system includes a set of grid monitoring devices and a controller. The set of grid monitoring devices is configured to couple to the infrastructure of a grid network to detect, monitor, and/or measure signals within the grid network that indicate generation and consumption of electrical energy. In particular, the grid monitoring devices are configured to detect the generation of renewable energy and report the amount of generated renewable energy to the controller for the controller to generate and allocate energy units representing the generated renewable energy. The controller of the system is configured to execute steps of a method to distribute a set of energy units to a set of energy tariffs according to a set of constraints indicated by the energy tariffs. The system can further generate recommendations for future energy generation and consumption to enable fulfillment of future energy tariffs.

### TECHNICAL FIELD

This invention relates generally to the field of energy allocation in a grid network and particularly to a system and method for allocating energy units between generators and consumers in a grid network.

### BRIEF DESCRIPTION OF THE FIGURES

FIG. 1 is a depiction of a system for allocating energy units.

FIG. 2 is a flowchart representation of a method for allocating energy units.

FIG. 3A is a flowchart representation of one variation of the method for allocating energy units.

FIG. 3B is a flowchart representation of one variation of the method for allocating energy units.

FIG. 4 is a flowchart representation of one variation of the method for allocating energy units, including future predictions.

### DESCRIPTION OF THE EMBODIMENTS

The following description of embodiments of the invention is not intended to limit the invention to these embodiments but rather to enable a person skilled in the art to make and use this invention. Variants, variations, configurations, embodiments, implementations, example implementations, and examples described herein are optional and are not exclusive to the variants, variations, configurations, embodiments, implementations, example implementations, and examples they describe. The invention described herein can include any and all permutations of these variants, variations, configurations, embodiments, implementations, example implementations, and examples.

Generally, the term “can,” as utilized herein, indicates an action or attribute of the system, which may or may not be executed by or be applicable to the system, depending on the implementation or embodiment of the system.

Generally, the term “include,” as utilized herein, can mean “comprise,” “consist of,” or “consist essentially of,” and is not restricted to any one of the above interpretations throughout.

Generally, the term “a set of,” as utilized herein, refers to one or more of the subject objects. Additionally, the terms “first,” “second,” “third,” etc., as utilized herein, do not imply an order but simply identify multiple instances of a step or component unless an order or series is otherwise implied.

Generally, the term “representative,” as utilized herein, indicates a central tendency statistic such as a mean or median of a particular data type over a short period of time suitable for use in the calculation of operational parameters.

Generally, the term “distribution,” as utilized herein, represents any characterization of data that approximates a true distribution of the data and is not intended to imply any degree of accuracy.

Generally, the term “defining,” as utilized herein, describes elements of a subject, is open-ended, and does not exclude additional unrecited elements or method steps.

Generally, the capitalized terms “Step” and “Steps,” as utilized herein, refer to any step or steps of a method depicted in a figure or any variant or more specific implementation of those depicted steps.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media, such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the following detailed description and from the figures and claims, modifications and changes can be made to the embodiments of the invention without departing from the scope of this invention as defined in the claims.

### 1. System for Allocating Energy Units

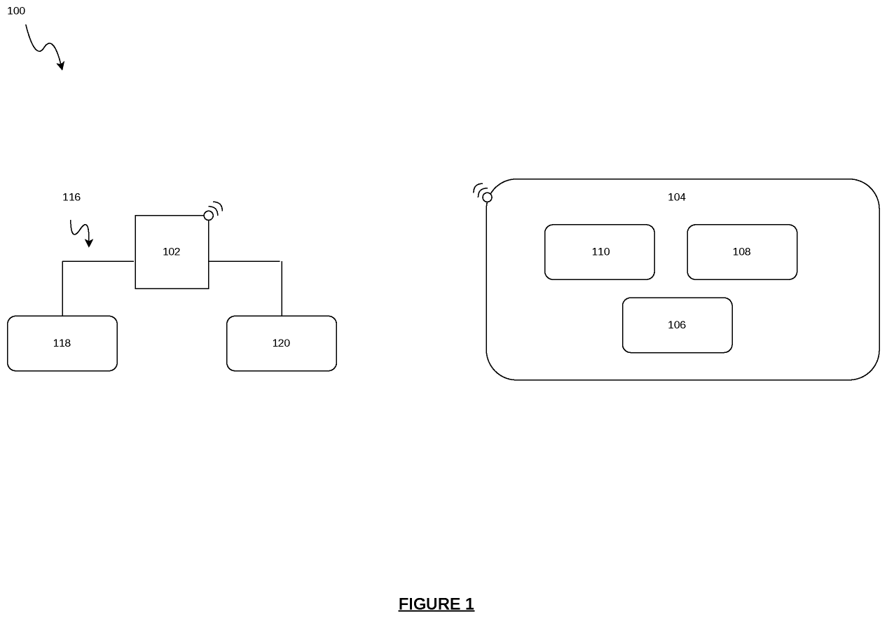

Generally, as shown in FIG. 1, the system for dynamically allocating energy units between generators 118 and consumers 120 in a grid network 116 (hereinafter “the system”) includes: a set of grid monitoring devices 102; and a controller 104 104. The set of grid monitoring devices 102 is distributed in the grid network 116 and configured to receive: a set of generation signals associated with the set of generators 118 during an allocation period; and a set of consumption signals associated with the set of consumers 120 during the allocation period. The controller 104 is configured to: calculate generation quanta for the allocation period based on the set of generation signals; calculate consumption quanta for the allocation period based set of consumption signals; calculate a set of energy units 112 based on the generation quanta, each energy unit in the set of energy units 112 characterized by a set of energy unit attributes including a generation timestamp; store the set of energy units 112 in an energy unit inventory 106; access a cost function 110 configured to calculate a cost of allocation of an energy unit to an energy tariff based on the set of energy unit attributes including a generation timestamp and a set of energy tariff attributes including an eligibility interval of generation timestamps.

The controller 104 is further configured to execute a first allocation action to allocate energy units from the energy unit inventory 106 to a set of energy tariffs 114 by: deriving a set of constraints based on the set of energy tariffs 114 wherein each energy tariff in the set of energy tariffs 114 defines a set of constraints including at least the eligibility interval; identifying a first set of eligible energy units within the energy unit inventory 106 based on the set of constraints, wherein each eligible energy unit in the set of eligible energy units is characterized by a generation timestamp within the eligibility interval; and calculating a distribution of energy units in the first set of eligible energy units to the set of energy tariffs 114 that fulfill the set of constraints of each energy tariff in the set of energy tariffs 114 by minimizing a total cost of the distribution, based on the cost function 110.

### 2. Method for Allocating Energy Units

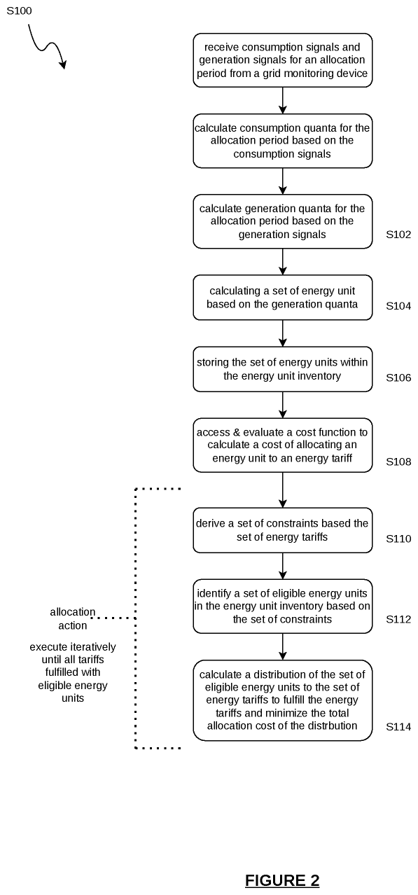

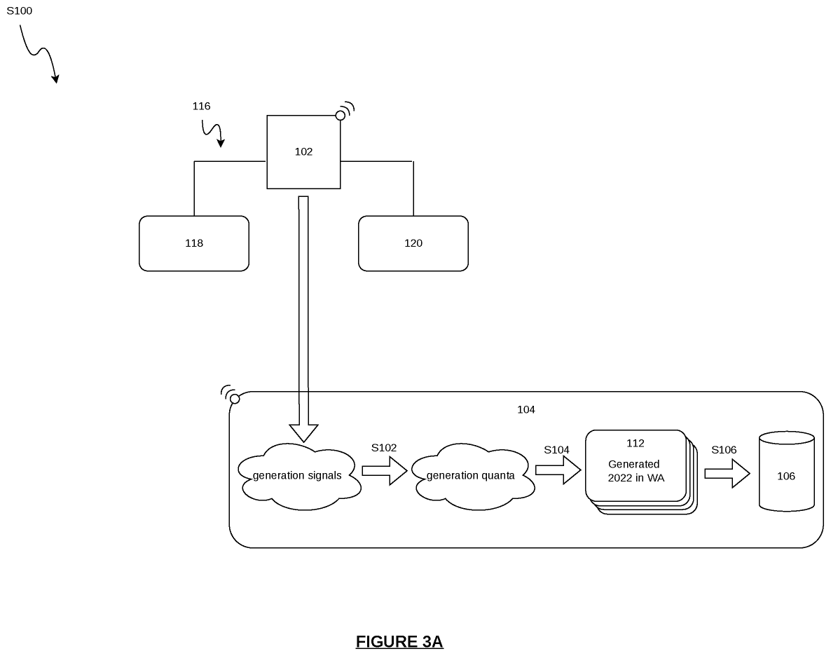

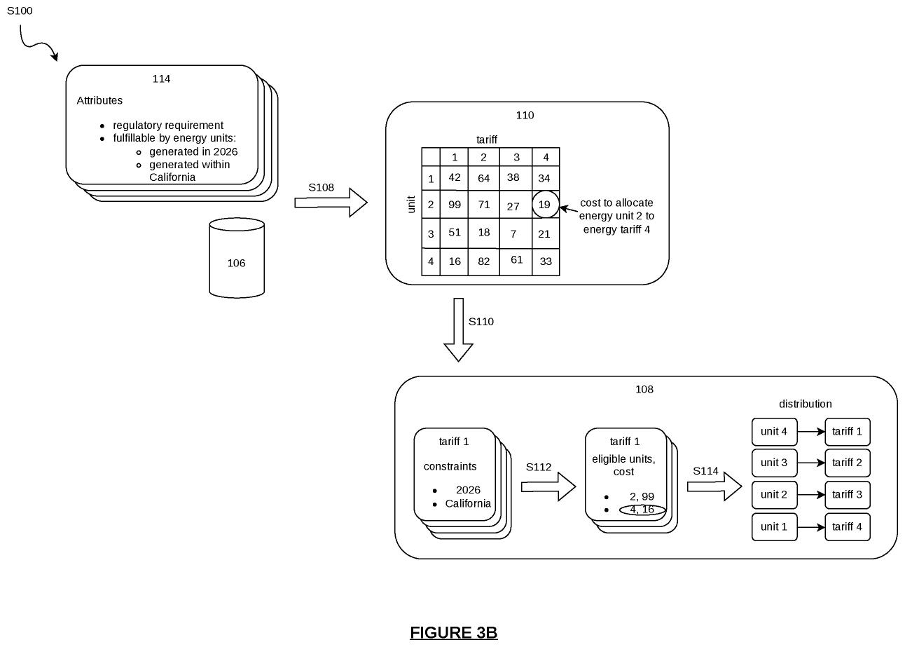

Generally, as shown in FIGS. 2, 3A, and 3B, the method for dynamically allocating energy units between a set of generators 118 and a set of consumers 120 in a grid network 116 (hereinafter “the method S100”) includes: accessing generation quanta for an allocation period based on a quantized total of energy generation during the allocation period in Step S102; calculating a set of energy units 112 based on the generation quanta, each energy unit in the set of energy units 112 characterized by a set of energy unit attributes including a generation timestamp in Step S104; storing the set of energy units 112 in an energy unit inventory 106 in Step S106; and accessing a cost function 110 configured to calculate a cost of allocation of an energy unit to an energy tariff based on the set of energy unit attributes including a generation timestamp and a set of energy tariff attributes including an eligibility interval of generation timestamps in Step S108.

The method S100 further includes, during a first allocation action, allocating energy units from the energy unit inventory 106 to a set of energy tariffs 114 by: deriving a set of constraints based on the set of energy tariffs 114 wherein each energy tariff in the set of energy tariffs 114 defines a set of constraints including at least the eligibility interval in Step S110; identifying a first set of eligible energy units within the energy unit inventory 106 based on the set of constraints, wherein each eligible energy unit in the set of eligible energy units is characterized by a generation timestamp within the eligibility interval in Step S112; and calculating a distribution of energy units in the first set of eligible energy units to the set of energy tariffs 114 that fulfill the set of constraints of each energy tariff in the set of energy tariffs 114 by minimizing a total cost of the distribution, based on the cost function 110 in Step S114.

### 3. Applications

Generally, the energy unit allocation system and the associated method provide a comprehensive technical solution for managing the allocation, banking, and settlement of energy units within grid networks 116. The energy unit allocation system includes a set of grid monitoring devices 102 and a controller 104 that work in coordination to ingest grid signals, compute generation and consumption quanta, optimize energy unit distribution across tariffs and compliance programs, and manage the complete lifecycle of allocation records from creation through settlement and retirement. The system 100 executes the method S100 to allocate energy units from renewable energy generation sources to particular energy tariffs. The system 100 is configured to perform allocation of any kind of energy unit, including but not limited to renewable energy certificates (RECs), alternative energy certificates (AECs), and energy attribute certificates (EACs) to any type of energy tariff, including but not limited to regulatory requirements (such as Renewable Portfolio Standards and Renewable Energy Standards) and voluntary subscriptions. More specifically, the system can allocate energy units to energy tariffs in a manner that fulfills constraints of each energy tariff, such as physical and/or contractual constraints, while minimizing a cost function 110 representing the cost of allocating particular energy units to particular energy tariffs. Thus, by more efficiently allocating energy units derived from renewable energy sources, the system enables multiple practical applications further described below.

Generally, the system 100 and the method S100 improve the efficiency of matching energy units to energy tariffs compared to manual or static allocation techniques. The method S100 improves the temporal resolution of energy allocation across heterogeneous grid measurement systems by ingesting, normalizing, and processing grid signals from heterogeneous sources (e.g., including grid monitoring devices of the system as well as external grid data sources). The method S100 includes steps to accurately represent grid signals (e.g., both generation signals and consumption signals) and thereby improves the accuracy of generation and allocation of energy units based on those grid signals. Further, the method S100 includes steps to prevent mismatched allocations of ineligible energy units to energy tariffs that cannot be otherwise reconciled by manual or static methods. The system 100 can iteratively execute the method S100 to allocate and re-allocate energy units based on the available energy units within the energy unit inventory and the set of constraints of a set of energy tariffs to optimize allocation of energy units to energy tariffs in a way that minimizes the total cost of allocation, thereby enabling the system 100 to iteratively refine allocations.

In one implementation, the system is configured to allocate energy units to both regulatory energy tariffs and voluntary subscriptions. For example, a grid operator or utility can offer voluntary subscriptions to consumers 120 wherein the grid operator and the consumer execute a contractual agreement indicating that energy units will be allocated to the consumer based on the amount of energy consumed by the consumer. The system 100 is configured to fulfill the contractual agreements of the subscriptions while also selectively allocating energy units to regulatory energy tariffs to ensure regulatory compliance of a utility and/or grid operator. For example, the controller 104 of the system can execute the method to prioritize fulfillment of regulatory energy tariffs, thereby triggering the cost function 110 to assign higher costs to allocating energy units to voluntary subscriptions than to regulatory energy tariffs. Therefore, the system and the associated method improve regulatory compliance of grid operators and utilities while also enabling voluntary subscription fulfillment in a way that incentivizes renewable energy production and decreases the risk of double-counting energy units.

In one application, the system increases incentives for grid operators to invest in renewable energy generation sources by improving the ability of the grid operator to offer subscriptions to energy consumers 120 and other parties that intend to claim credit for renewable energy generation. For example, by operating across multiple time increments and tariff types, the system can minimize the quantity of unallocated energy units, thereby increasing the profitability of new renewable generation sources to grid operators. Thus, the system can incentivize an increase in the rate of additional renewable energy generation added to an electrical grid.

In another application, the system can execute further steps of the method to predict energy generation and energy consumption over a future period of time or an allocation period. In this application, the system can allocate energy units according to expected future conditions. For example, given an expected surplus in renewable energy generation in the future, the system can allocate energy units to energy tariffs over smaller allocation periods (e.g., hourly or daily energy tariffs) and allocate future surplus energy generation toward longer-term (e.g., yearly) energy tariffs.

In yet another application, the system can execute further steps of the method to calculate generation signals by the set of generation sources that would decrease allocation costs based on a given set of energy tariffs 114 and predicted consumption signals. In this application, the system can directly transmit instructions to generators 118 to command or recommend generation schedules that decrease energy unit allocation costs over the set of energy tariffs 114, thereby improving alignment between energy supply and energy demand. Therefore, the system can execute the method to derive future generation instructions according to a target future generation schedule that will result in a higher availability of energy units and, therefore, enable renewable energy generators 118 to fund the expansion of renewable energy infrastructure.

In yet another application, the system can execute further steps of the method to calculate consumption signals that would decrease allocation costs based on a given set of energy tariffs 114 and predicted generation signals. In this application, the system can directly transmit instructions to consumers 120 to command or recommend consumption schedules that decrease energy usage and energy unit allocation costs over the set of energy tariffs 114, thereby further aligning energy demand with energy supply. Therefore, the system can execute the method to derive future consumption schedules that can incentivise consumption during times of renewable energy generation and decrease reliance on non-renewable sources.

In yet another application, the system can predict a set of future energy tariffs that reduces allocation costs given predicted generation signals and consumption signals. In this application, the system can identify the set of constraints and allocation periods that minimize the cost function 110 based on the predicted generation signals and consumption signals. The system 100 can transmit instructions or recommendations of future energy unit allocations to energy tariffs that further incentivize the utilization of predicted energy generation by predicted energy consumption. Therefore, the system can execute the method to derive future voluntary subscription agreement terms in a way that maximizes the number of subscriptions the grid operator or utility can fulfill while incentivizing expansion of renewable energy generation with revenue from subscriptions and energy unit sales.

In yet another application, the system is configured to allocate energy units to energy tariffs (both voluntary subscriptions and regulatory requirements) at an increased frequency compared to allocation without the system and associated method. For example, the system can execute the method with an hourly frequency to capture generation and consumption signals with higher resolution and therefore generate energy units representing the renewable energy generation more accurately. Further, the system can execute allocation actions to allocate energy units to energy tariffs with increased frequency, such as hourly or daily. By increasing the frequency of allocation, the system enables more accurate allocation of energy units to each energy tariff.

### 4. System Components

FIG. 1 illustrates the elements that include a system of the present invention. The system 100 is a combination of physical infrastructure that includes a controller 104, and one or more grid monitoring devices 102 (such as sensors or meters installed at power plants, energy storage units, businesses, and/or homes) that transmits and receives signals (such as electricity, data, or instructions) and performs tasks (such as allocating energy units).

### 4.1. Grid Monitoring Devices

As shown in FIG. 1, the system 100 includes a set of grid monitoring devices 102 distributed in a grid network 116 and configured to receive a set of generation signals from a set of generators 118 and a set of consumption signals from a set of consumers 120. The grid network 116 of grid monitoring devices 102 is communicatively coupled with generators 118, consumers 120, and the controller 104. A grid-monitoring device can include any sensor, monitor, or meter configured to measure the amount of energy that is generated by a point source or aggregated by substations in a grid network 116. For example, grid networks typically employ a set of voltage sensors distributed amongst electric transmission lines for collecting data and performing analytics related to energy generation, distribution, and consumption. Grid-monitoring devices can access and/or communicate with a grid database or a set of grid databases that collect, store, and organize energy measurements made at nodes in a grid network 116 by other grid-monitoring devices. Further, the system 100 can access the grid databases to obtain generation signal and consumption signal data packets or data summaries. The system 100 can integrate consumption signals and generation signals from a set of grid monitoring devices 102 in order to normalize and associate generation quanta and consumption quanta.

The set of generators 118 can include any producer of energy within the grid network 116 including, but not limited to, renewable energy such as solar, wind, geothermal, biofuel, or nuclear power or fossil-fuel-based energy sources such as coal, oil, or natural gas plants or energy storage facilities such as batteries, pumped hydroelectric facilities, flywheels, compressed air energy storage, thermal energy storage (such as molten salt receivers or industrial heaters), or chemical energy storage (such as hydrogen cells). Grid networks typically include a mixture of generation sources that deliver electricity via transmission and distribution lines to regional hubs or substations, where electricity is further transmitted to consumers 120. The set of consumers 120 can include any user of the electrical energy distributed on the grid network 116 and produced by the set of generators 118, such as homes, offices, businesses, transit providers, and even the generators 118 themselves.

### 4.2. Controller

As shown in FIG. 1, the system 100 includes a controller 104 configured to execute the Steps of the method. Generally, the controller 104 can include one or more processors configured to execute computational logic for dynamic allocation, banking, and/or settlement of energy units in a grid network 116. The controller 104 can orchestrate the acquisition, normalization, and/or processing of generation signals and consumption signals received from grid monitoring devices 102 distributed throughout the grid network 116. In one implementation, the controller can compute generation quanta and/or consumption quanta for defined allocation periods by aggregating and/or normalizing heterogeneous signal data. The controller 104 can calculate a set of energy units 112 based on the generation quanta, assign attributes to each energy unit (e.g., generation timestamp, location, energy type, and/or allocation status), and/or store the resulting energy units in an energy unit inventory 106.

Additionally, the controller can access and/or apply a cost function 110 to determine costs of allocating specific energy units to specific energy tariffs, where the cost function 110 can incorporate variables such as generation timestamp, location, tariff eligibility intervals, tariff classification, fulfillment time, and/or tariff value. The controller 104 can derive allocation constraints from energy tariff attributes, compliance standards, and/or system configuration, and can execute optimization algorithms (e.g., linear programming solvers, rule-based engines, and/or machine learning models) to calculate a distribution of energy units that fulfills the set of constraints while minimizing total allocation cost.

Further, the controller can track and/or update settlement state metadata for each allocation record, supporting a multi-stage settlement lifecycle (e.g., unsettled, preliminarily settled, and/or retired) and enforcing unsettleability constraints to prevent double-counting of renewable attributes and/or certificates. The controller 104 can support retroactive re-optimization of allocations by enabling selective rollback and/or reallocation of unsettled or preliminarily settled records when new certificates are acquired, or allocation conditions change, without altering retired records.

In one implementation, the controller can generate structured outputs, including attestation reports, billing data, registry retirement instructions, scenario analysis reports, and/or settleability metrics. Additionally or alternatively, the controller can predict future generation and/or consumption quanta, forecast future tariffs, and/or generate instructions for generators 118 and consumers 120 to align supply and demand. The controller 104 can expose application programming interfaces for integration with external systems, including utility billing systems, REC registries, and/or consumer or operator dashboards. Thus, the controller addresses the challenges of matching time-varying energy generation to consumer load under temporal, locational, and contractual constraints, while preventing double-counting and enabling retroactive re-optimization without invalidating already-retired allocations.

In one implementation, the controller can include a single server installed within a primary data center of a utility. In this implementation, computational modules of the controller, including signal normalization, optimization, banking, and/or settlement modules, can execute on a monolithic software stack within one operating system instance. This architecture can simplify deployment and/or maintenance for small to medium grid networks 116 where real-time latency constraints are moderate.

In another implementation, the controller includes a set of processors communicating over a local or wide area network to execute steps of the method S100. For example, the method S100 can be decomposed into independently deployable microservices, each running in a container and/or virtual machine, and orchestrated by a container platform. In this implementation, signal ingestion, optimization, banking, settlement, and/or reporting services can communicate over an internal message bus, enabling horizontal scaling and/or fault isolation. This distributed architecture can be suitable for large-scale deployments (e.g., ISO/RTO-scale deployments) where throughput, redundancy, and/or fault tolerance requirements exceed the capabilities of a single server implementation. However, the controller can be implemented in any other means configurable to execute the method S100.

### 4.2.1. Cost Function

Generally, the controller is configured to execute and/or evaluate a cost function 110 to derive the cost of allocating an energy unit to an energy tariff. In one implementation, the controller can access, store, and/or update the cost function 110.

The cost function 110 can output a scalar cost value representing monetary cost, emissions-related cost, and/or a composite cost. In one implementation, the controller can retrieve a pre-defined cost function 110 from a data store, and/or can dynamically compute or update the cost function 110 based on current system parameters, environmental conditions, and/or regulatory requirements. The cost function 110 can assign different costs to candidate allocations based on temporal proximity, geographic proximity, tariff priority, and/or other factors, thereby enabling minimization of total allocation cost across energy units and tariffs. Thus, accessing and evaluating the cost function 110 provides a deterministic scalar metric for each candidate allocation of an energy unit with an energy tariff, which addresses the technical challenge of minimizing the monetary, operational, and emissions-related cost of allocating specific energy units to specific tariffs under complex constraints.

In one implementation, the cost function 110 can include a machine-learning model trained on historical allocation outcomes. For example, the method S100 can include training a machine-learning model (e.g., a regression model, a gradient-boosted tree, and/or a neural network); and executing, by the controller, the machine-learning model to predict marginal allocation cost as a continuous function of energy unit attributes and tariff attributes. In this implementation, the cost function 110 can capture non-linear interactions among input variables that a simpler algebraic cost function 110 may not represent.

In another implementation, the cost function 110 can include a hierarchical cascading function including multiple stages. For example, the cost function 110 can include: a coarse screening stage configured to apply a first cost sub-function (e.g., based on timestamp proximity) to prune infeasible or low-priority candidate allocations; a fine-grained stage configured to apply a second cost sub-function (e.g., a full economic and emissions model) to the reduced candidate set. This multiple-stage approach can accelerate large-scale optimization while preserving accuracy for the remaining candidate allocations.

In yet another implementation, the cost function 110 includes a linear combination of weighted attributes. For example, the cost function 110 can assign a first weight to a monetary cost term (e.g., energy price per unit multiplied by allocated quantity), a second weight to an emissions term (e.g., carbon intensity of the energy unit multiplied by allocated quantity), a third weight to a temporal alignment term (e.g., a penalty proportional to a time difference between a generation interval and a tariff fulfillment interval), and a fourth weight to a locational compliance term (e.g., a penalty that increases when a generation location falls outside a preferred or required region). Additionally or alternatively, the cost function 110 can include terms for banking age (e.g., a function of time remaining until expiry of a banked energy unit), contract utilization (e.g., a measure of how closely an energy tariff tracks a target procurement profile), and/or risk of non-compliance (e.g., a step or sigmoid function that increases cost as allocations approach a program limit). For example, the cost function 110 can compute an allocation cost for a candidate pairing of an energy unit and a tariff by forming a feature vector representing the selected attributes, multiplying the feature vector by a corresponding weight vector, and summing the resulting products to generate a scalar cost value. This implementation can provide a lightweight and interpretable formulation, which may be advantageous for deployments where transparency and/or auditability are desired. However, the cost function 110 can be implemented in any other form such that it is able to determine an allocation cost based on energy unit attributes and energy tariff attributes.

In the context of system 100, the “cost” may indicate a relative risk or monetary value. For example, the cost function 110 evaluated in the method S100 can model potential losses experienced by a utility responsible for allocating energy units to energy tariffs to fulfill the energy tariffs. More specifically, a cost of allocation indicates a measure of risk to the utility, whether that risk entails monetary loss, inability to fulfill a tariff (e.g., a contractual loss), or another form of risk or loss. Therefore, the utility may choose to execute the Steps of the Method to minimize risk or loss, thereby minimizing the cost function 110 (e.g., minimizing the total cost of all allocations performed within the Method).

### 4.2.2. Allocation Engine

As shown in FIG. 1, the system 100 can further include an allocation engine 108, wherein the allocation engine 108 is configured to calculate a distribution of energy units to a set of energy tariffs 114 such that a set of constraints associated with the energy tariffs is fulfilled. In one implementation, the allocation engine 108 is a software module stored on the controller or accessed by the controller. The controller 104 is thereby configured to execute the allocation energy to calculate a distribution of energy units to a set of energy tariffs 114.

The allocation engine 108 can include a program, model, machine learning model, or set of algorithms. Via the allocation engine 108, the system 100 is configured to allocate or distribute the energy units so as to fulfill all constraints, or, in the case that no valid solution can be found, to fulfill as many constraints as possible given an ordered priority of objectives, or to partially fulfill the set of constraints. In one implementation, the controller is configured to input the energy unit inventory 106, the set of constraints, the set of energy tariffs 114, and the cost function 110 into the allocation engine 108. Then, based on those inputs, the allocation engine 108 can execute one or more allocation actions to determine a distribution of energy units to a set of energy tariffs 114 to fulfill the tariffs while minimizing the total cost of the distribution without violating any constraints in the set of constraints.

### 4.2.3. Energy Unit Inventory

In one implementation, the controller 104 can store, access, and/or store an energy unit inventory 106. The energy unit inventors is a database of all of the energy units available for allocation to an energy tariff, as well as energy units that have previously been allocated to energy tariffs or retired to a registry.

Generally, the energy unit inventory 106 can store energy units and the energy unit attributes associated with energy units. Each record in the energy unit inventory 106 can correspond to a discrete energy unit and can include source attributes such as generation timestamp, generation location, generator identity, energy type, and/or metadata relevant to allocation eligibility. Additionally, the energy unit inventory 106 can record and update an allocation status for each energy unit, which can include states such as available, settled, retired, and/or expired. The energy unit inventory 106 can write newly calculated energy units into durable storage immediately after generation quanta computation, ensuring that computable units are retained between calculation, optimization, and/or settlement workflows.

### 5. Method for Allocating Energy Units

Generally, as shown in FIG. 2, the controller 104 of the system 100 is configured to execute Steps of the Method S100 to dynamically generate and allocate energy units in a grid network 116. The method S100 includes: accessing generation quanta for an allocation period in Step S102; calculating a set of energy units 112 based on the generation quanta in Step S104; storing the set of energy units 112 in an energy unit inventory 106 in Step S106; and accessing a cost function 110 to calculate a cost of allocation of an energy unit to an energy tariff in Step S108. The controller 104 is further configured to execute one or more allocation actions of the method S100 by: deriving a set of constraints based on the set of energy tariffs 114 in Step S110; identifying a first set of eligible energy units within the energy unit inventory 106 based on the set of constraints in Step S112; and calculating a distribution of eligible energy units to the set of energy tariffs 114 that fulfills the set of constraints and minimizes a total cost of the distribution, based on the cost function 110 in Step S114.

In one implementation, the system 100 is configured to execute the method S100, wherein the allocation period is one hour. Therefore, the controller 104 is configured to compute generation quanta and consumption quanta hourly that represent energy generation (including renewable energy generation) and energy consumption in the grid network 116 within that hourly period. However, the controller 104 can execute the method with any duration of allocation period, including but not limited to one hour, one day, one week, and/or one month.

In another implementation, the system 100 is configured to execute a set of allocation actions, wherein each allocation action includes allocation of one or more energy units to one or more energy tariffs to fulfill the tariffs while minimizing the cost of allocation. For example, the controller 104 can execute steps of the method S100 to execute allocation actions with an hourly allocation frequency. However, the controller 104 is configured to execute any number of allocation actions at any frequency, constant or non-constant, to distribute energy units to energy tariffs to fulfill the energy tariffs without violating the set of constraints.

In one implementation, the system 100 is configured to execute further steps of the method including but not limited to: computing consumption quanta and associating the consumption quanta with voluntary tariffs; updating an allocation data base and/or an energy unit inventory 106 to reflect allocation status of each energy unit; unsettling a selected allocation action (e.g., the distribution of a set of energy units 112 to one or more energy tariffs) and/or re-settling that allocation action at a later time (e.g., with a different set of energy units 112 distributed to the one or more energy tariffs); predicting consumption quanta, generation quanta, energy units, energy tariffs, and distributions of energy units to energy tariffs for a future period; generating and transmitting target consumption instructions and target generation instructions; transferring energy units to consumer, subscribers, or buyers; and interfacing with energy unit registries to retire or otherwise report energy units.

### 5.1. Compute Generation Quanta

Generally, as shown in FIGS. 2 and 3A, the system 100 is configured to access and/or compute generation quanta for an allocation period based on a quantized total of energy generation during the allocation period in Step S102. Generation quanta are a set of quantized and normalized energy totals measured over the allocation period or another such time period that represents energy generated during the period. The system 100 calculates generation quanta using the generation signals collected by the grid monitoring devices 102. The grid monitoring devices 102 measure generation signals as amounts of energy that pass through nodes of a grid network 116 by observing electromagnetic phenomena such as voltages, currents, and power (typically measured in kilowatts or megawatts) from electricity in transmission lines and energy hubs. The system 100 can link, connect, or relate, via a ledger, database, or transaction, an amount of energy measured by a grid monitoring device with a generator that produced the energy or with a generator that produced energy within the same allocation period that the measurement was taken. Because signals from disparate grid monitoring devices 102 in a plurality of locations can vary in their accuracy, precision, and units of measurement, calculating generation quanta can include the step of normalizing generation signals from a variety of inputs into a consistent format for aggregation and quantization.

### 5.2. Compute Consumption Quanta

In one implementation, as shown in FIG. 2, the system 100 is configured to access and/or calculate consumption quanta over the allocation period. Consumption quanta are a set of quantized and normalized energy totals measured over the allocation period or another such time period representing energy that was consumed during the allocation period. The system 100 calculates consumption quanta using the consumption signals collected by the grid monitoring devices 102. The system 100 can link, connect, or relate, via a ledger, database, or transaction, an amount of energy measured by a grid monitoring device with a consumer that used the energy or with a consumer that used energy within the same allocation period that the measurement was taken. Because signals from disparate grid monitoring devices 102 in a plurality of locations can vary in their accuracy, precision, and units of measurement, calculating consumption quanta can include the step of normalizing signals from a variety of inputs into a consistent format for aggregation and quantization.

### 5.3. Associate Consumption Quanta With Subscriptions

In one implementation, wherein the set of energy tariffs 114 includes a set of voluntary subscriptions and a set of regulatory requirements, the method includes associating consumption quanta with one or more voluntary subscriptions. Generally, each voluntary subscription includes an agreement for the allocation of energy units to the subscriber based on the energy consumption of the subscriber. The controller 104 of the system 100 is therefore configured to determine an amount of energy consumed by each subscriber associated with a subscription, record and track the energy consumption, and allocate energy units to the subscription based on the amount of energy consumed. For example, the controller 104 can: access consumption quanta for the allocation period based on a quantized total of energy consumption during the allocation period; and, for each voluntary subscription in the set of voluntary subscriptions, determine an amount of energy consumed by a consumer associated with the voluntary subscription based on the consumption quanta. Further, the controller 104 can calculate the distribution of energy units to the set of energy tariffs 114 by allocating a number of energy units to each voluntary subscription proportional to the amount of energy consumed by the consumer associated with the voluntary subscription.

In one implementation, the system 100 is configured to associate the set of consumption quanta with the set of subscriptions. Subscriptions are liens, contracts, or obligations in the form of legal records or digital tokens that mandate that a subscriber holding said subscription be allocated energy units of certain quantities and attributes over an allocation period in proportion to the amount of energy consumed. Consumers (such as a business, private, or public infrastructure) can also hold subscriptions, and/or subscriptions can be held by parties outside of the grid network 116 managed by, or connected to, the system 100. Thus, by associating consumption quanta with subscriptions, the system 100 can aggregate energy of particular energy types (such as renewables) to subscriptions as a proportion of energy consumption for consumers 120 who are also subscribers.

In one example, a business with a brick-and-mortar retail location consumes energy connected to the grid network 116 to power the operation of the business. In this example, the business can purchase at least one energy unit that is associated with the actual generation of renewable energy from a grid operator in order to offset the deleterious environmental impact of the business's greenhouse gas emissions. The business can request, for example, a number of energy units proportional to, or equal to, the amount of energy that said business consumes over an allocation period. The business derives a benefit from purchasing the claim to the renewable energy that was generated on the grid network 116, and a grid operator derives a benefit from a purchase agreement for the energy unit. The grid operator is then obligated to allocate a set of energy units 112 to the business, and this obligation can be recorded in a registry as a subscription; in this example, said business is both a consumer and subscriber with a subscription.

Additionally, the system 100 can associate consumption quanta with subscriptions held by subscribers who are not themselves also consumers 120 connected to the same grid network 116. In this manner, the subscriptions are based on the total number of energy units that can be allocated on the grid network 116 writ large. In this example, an entity or utility external to the grid network 116, or one that does not consume energy on the grid network 116, may wish to purchase energy units associated with the actual generation of renewable energy (e.g., to incentivize a transition to renewable energy generation sources). The utility may request, for example, a certain number of energy units that are generated within an allocation period. The utility may derive a benefit from holding energy units to be sold later, from reallocating energy units to other subscriptions, or from offsetting greenhouse gas emissions created in a distant location or on a different grid network 116. The grid operator is then obligated to allocate a set of energy units 112 to the utility, and this obligation can be recorded as a subscription. In this example, said utility is a subscriber with a subscription but is not a consumer. Further steps of the method (discussed below) allow for the definition and allocation of energy units to the subscriptions.

The system 100 associates consumption quanta and subscriptions in order to match the energy totals of a consumer or a subscription to which an energy unit is obligated or due. The system 100 can associate consumption quanta in the form of a database entry, a bundling of files, or storage in a ledger, such as on a cryptographic blockchain. The amount of energy that can be associated can be measured in units of, for example, kilowatt-hours (kWh) or megawatt-hours (MWh).

Additional information about the consumer or the subscription in the form of energy attributes can also be encoded with consumption quanta as part of the association. Energy attributes can include additional information associated with energy measurements, such as, but not limited to, location data of a consumer, the category of consumer (such as home, business, or public sector), renewability class (i.e., renewable or non-renewable energy consumed), current consumption status, and carbon footprint of consumption. Energy attributes can be encoded or otherwise included with energy totals in a measurement or allocation period to form the association between consumption quanta and subscriptions.

The set of subscriptions is ultimately committed, promised, or otherwise obligated to be matched with energy units, and the subscriptions are held by, associated with, or representative of parties to whom energy units can be sold or otherwise allocated. A subscription held by a consumer that used an applicable amount of energy as the total in the consumption quanta, or that used a particular percentage of energy of the total in the consumption quanta, or which is obligated to be matched with an energy unit having a certain energy attribute (such as a type of renewable energy) may be associated with a set of consumption quanta.

### 5.4. Calculate Energy Units

As shown in FIGS. 2 and 3A, the system 100 is further configured to calculate a set of energy units 112 from the set of generation quanta over the allocation period in Step S104. More specifically, the controller 104 is configured to calculate a set of energy units 112 based on the generation quanta, each energy unit in the set of energy units 112 characterized by a set of energy unit attributes, including a generation timestamp. For example, calculating the set of energy units can include generating a set of serialized energy units by transforming aggregated generation quanta into discrete, uniquely identifiable data objects, each including a structured attribute vector including temporal, geographic, and/or classification dimensions.

Calculating an energy unit can consist of aggregating generation quanta in units of energy (kWh or MWh), serializing the aggregation of generation quanta by giving the energy unit a unique identifier, and associating the generation quanta with energy attributes related to the nature of the generator or set of generators 118. Energy attributes included in a calculated energy unit can include additional information associated with energy measurements from the grid monitoring devices 102 such as, but not limited to, location data of a generator, the time of energy generation, the type of energy generator, renewability class (i.e. renewable or non-renewable energy generated), current generator status, or carbon footprint (e.g., carbon dioxide equivalent emissions per kilowatt). The attribute profile can be encoded, bundled, or otherwise included with measured energy totals to form the energy unit. Each energy unit is serialized with an identifier, such as a number or alphanumeric indicator, so that each energy unit is unique for tracking and allocation purposes. Energy units may take the form of a suitable virtual item to be allocated, such as immutable or fungible digital tokens, database or blockchain entries, or data entries stored on physical computer-readable media. Energy units can include renewable energy certificates (RECs) or renewable energy credits and can serve as validation that an amount of energy (typically 1 MWh) of renewable energy was generated and transmitted to the grid network 116.

Energy units may be created and serialized by a grid operator or regulatory schema external to the system 100, in which case the system 100 calculates energy units by aggregating generation quanta and energy attributes with existing serialized contracts, digital tokens, or obligations. The system 100 can only calculate a quantity of energy units within an allocation period according to a set of calculation constraints, which may include mandates for minimum, average, or maximum energy units that can be calculated for a given allocation period.

In another application, the system 100 can calculate and predict the quantity of energy units to be allocated to a set of future energy tariffs. The controller 104 can calculate a distribution of energy unit allocation that satisfies a set of future constraints, wherein the future constraints are functions of predicted or modeled generation quanta, consumption quanta, and/or energy unit demand.

### 5.5. Derive Cost of Allocations

Generally, as shown in FIGS. 2 and 3B, the controller 104 can access and/or evaluate a cost function 110 configured to quantify an allocation cost for assigning a given energy unit to a given energy tariff in Step S108. More specifically, the cost function 110 can receive as input a set of attributes associated with the energy unit, such as a generation timestamp, generation location, energy type, and/or allocation status, and a set of attributes associated with the energy tariff, such as an eligibility interval of generation timestamps, tariff classification, fulfillment deadline, and/or tariff value. In one implementation, the controller 104 can access a multi-component cost function configured to evaluate candidate allocations based on a weighted combination of temporal alignment, geographic alignment, tariff prioritization, and allocation scarcity metrics, wherein the cost function operates over feature vectors derived from both energy unit attributes and tariff constraints.

In one implementation, the controller 104 accesses a cost function 110 configured to calculate a cost of allocation of an energy unit to an energy tariff based on: the set of energy unit attributes, including a generation timestamp; and a set of energy tariff attributes, including an eligibility interval of generation timestamps. For example, the controller 104 can input the energy unit attributes and the energy tariff attributes into the cost function 110, and the cost function 110 can assign: a first cost to allocating a first energy unit to the energy tariff, wherein the first energy unit is characterized a first generation timestamp within the eligibility interval; and a second cost, less than the first cost, to allocating a second energy unit to the energy tariff, wherein the second energy unit is characterized by a second generation timestamp within the eligibility interval and preceding the first generation timestamp. The cost function 110 can therefore be configured to assign costs to allocating energy units to energy tariffs, wherein allocation of energy units with earlier generation timestamps is prioritized over allocation of energy units with more recent timestamps. In this example, calculating the distribution of energy units in the first set of eligible energy units to the energy tariff by minimizing the total cost of the distribution includes allocating the second energy unit to the energy tariff. The cost function 110 prioritizes allocation of energy units with older generation timestamps over allocation of newer timestamps, thereby prioritizing use of all eligible energy units before the energy unit can expire or effectively age out of eligibility to any energy tariff.

In one implementation, the cost function 110 is configured to assign a cost to an allocation of an energy unit to an energy tariff based on the generation location of the energy unit. For example, the set of energy unit attributes can include a generation location that indicates a location wherein the renewable energy represented by the energy unit was generated. Further, the energy tariff can include an attribute defining an eligible generation area, the set of constraints includes the eligible generation area, and the set of eligible energy units for allocation to that particular energy tariff is each characterized by a generation location within the eligible generation area. In this implementation, the cost function 110 can assign: a first cost to allocating a first energy unit to the energy tariff, wherein the first energy unit is characterized by a first generation location, a first distance from the generation area locus of the eligible generation area; and a second cost, less than the first cost, to allocating a second energy unit to the energy tariff, wherein the second energy unit is characterized by a second distance, less than the first distance, from the generation area locus of the eligible generation area. As a result, minimizing the total cost of the distribution of energy units to a set of energy tariffs 114 includes allocating the second energy unit to the energy tariff that specifies the eligible generation area.

For example, an energy tariff can specify an eligible generation area, such as an area within a 100-mile radius of a consumer location, and a generation area locus, such as the location of the consumer. The energy tariff may also include a preference or requirement for energy units allocated to the tariff to be generated as close to the consumer location (the generation area locus) as possible. Therefore, the cost function 110 can support the fulfillment of the energy tariff by assigning a higher cost to allocating energy units generated far away from the consumer location to the energy tariff and assigning a lower cost to allocating energy units generated near the consumer location to the energy tariff. Thus, when the distribution of energy units to the energy tariffs is calculated, minimizing the cost function 110, the energy units generated near the consumer location are more likely to be allocated to the energy tariff specifying the eligible generation area.

In one implementation, the cost function 110 can derive the cost of allocating an energy unit to a particular tariff based on a classification of the tariff. For example, an energy tariff can include a tariff classification attribute indicating whether the energy tariff is a voluntary subscription or a regulatory requirement. The cost function 110 can thus assign: a first cost to allocating a first energy unit to the voluntary subscription; and a second cost, less than the first cost, to allocating the first energy unit to the regulatory requirement. Thus, to minimize the total cost of the distribution of energy units to the energy tariffs, the first energy unit with the lower cost is allocated to the regulatory requirement. Therefore, the cost function 110 prioritizes fulfilling regulatory requirements and may assign costs to the allocations to ensure that regulatory requirements are fulfilled before voluntary subscriptions.

In one implementation, the cost function 110 can calculate allocation costs based on current conditions (e.g., time and date) and tariff fulfillment deadlines. For example, the set of energy tariff attributes for an energy tariff can include a tariff fulfillment deadline indicating a date and/or time by which energy units must be distributed to the energy tariff to fulfill the energy tariff. The cost function 110 can assign: a first cost to allocating a first energy unit to a first energy tariff characterized by a first tariff fulfillment deadline; and a second cost, less than the first cost, to allocating the first energy unit to the second energy tariff characterized by a second tariff fulfillment deadline preceding the first tariff fulfillment deadline of the first energy tariff. As a result, the controller 104 can calculate the distribution of energy units to the energy tariff to minimize the total cost of the distribution by allocating the first energy unit to the second energy tariff. This effectively enables the cost function 110 to enforce prioritization of fulfilling energy tariffs that have upcoming fulfillment deadlines before fulfilling energy tariffs that have plenty of time before their fulfillment deadline. Therefore, the cost function 110 can calculate allocation costs to enable fulfillment of energy tariffs based on their fulfillment deadlines.

In one implementation, the cost function 110 is configured to calculate the cost of allocating an energy unit to an energy tariff based on the tariff value of the energy tariff. For example, the set of energy tariff attributes can include a tariff value of each energy tariff, wherein the tariff value represents a monetary value or other value associated with fulfilling the energy tariff. In one implementation, the cost function 110 can assign: a first cost to allocating a first energy unit to a first energy tariff characterized by a first tariff value; and a second cost, less than the first cost, to allocating the first energy unit to a second energy tariff characterized by a second tariff value greater than the first tariff value. The cost function 110 can assign a lower cost to allocating energy units to higher value energy tariffs than to lower value tariffs. As a result, the cost function 110 enforces prioritization of fulfilling high-value energy tariffs over lower-value energy tariffs. For example, a particular energy tariff can be considered a high-value energy tariff if the consumer associated with the energy tariff has been a long-time customer of the utility or if the consumer has consumed a high amount of energy, thereby representing a higher value to the utility.

In one implementation, the cost function 110 is configured to calculate the cost of allocating an energy unit to an energy tariff based on a fulfillability factor of the tariff and/or an applicability factor of each energy unit. For example, the fulfillability factor of an energy tariff can indicate a relative ease or difficulty of allocating existing energy units to the energy tariff compared to other energy tariffs. An energy tariff with a low fulfillability factor may include several tariff attributes that set narrow constraints on what energy units are eligible to be allocated to the tariff, while an energy tariff with a high fulfillability factor may define few or no constraints and therefore be fulfillable by a large number of eligible energy units. The applicability factor of each energy unit is based on the set of energy unit attributes and indicates a relative ease of allocation of that energy unit to an energy tariff. For example, an energy unit with a high applicability factor may be allocatable to more energy tariffs (e.g., eligible for allocation to a high number of energy tariffs) than an energy unit with a low applicability factor.

In one implementation, the cost function 110 is further configured to: for each energy tariff in the set of energy tariffs 114, calculate an fulfillability factor for each energy tariff based on the set of constraints derived from the energy tariff and the set of energy tariffs 114, wherein a high fulfillability factor indicates relative ease of fulfillment of the energy tariff compared to a low fulfillability factor; and for each energy unit in the set of energy units 112, calculate an applicability factor based on the set of energy unit attributes of the energy unit and the energy unit inventory 106, wherein a high applicability factor indicates relative ease of allocation to an energy tariff compares to a low applicability factor. The cost function 110 can assign: a first cost to allocating a first energy unit characterized by a high applicability factor to a first energy tariff characterized by a high fulfillability factor; and a second cost, less than the first cost, to allocating the first energy unit to a second energy tariff characterized by a low fulfillability factor. As a result, the controller 104 can calculate the distribution of energy units to the energy tariff by minimizing the total cost of the distribution and allocating the first energy unit (high applicability) to the second energy tariff (low fulfillability). The cost function 110 is therefore configured to prioritize allocating high applicability energy units to low fulfillability energy tariffs, thereby increasing the chance that low fulfillability energy tariffs are still fulfilled. In this way, the cost function 110 effectively reserves energy units that are characterized by a set of energy unit attributes that make them applicable to many energy tariffs for allocation to tariffs that have narrow constraints.

### 5.6. Derive Constraints

Generally, as shown in FIGS. 2 and 3B, the system 100 is further configured to derive a set of constraints at least in part from the set of energy tariffs 114 in Step S110. The system 100 either generates a set of constraints or inherits a set of constraints and calculates, via the allocation engine 108, a distribution of energy units to the set of energy tariffs 114 that fulfills the set of constraints based on the cost of each energy unit in the set of energy units 112 and the set of consumption quanta for the given allocation period. In particular, the constraints can be generated by the controller 104 of the system 100.

In one implementation, the set of constraints, as a function of various inputs to the allocation engine 108, can include, but is not limited to: hourly- or annual-minimum, maximum, or average Carbon Free Electricity percentage (CFE %) (i.e. a set of requirements that kilowatt-hours of energy consumption in a set of consumers 120 are mapped or matched to energy generated by carbon-free electricity sources in a set of generators 118, such as solar and wind); costs as determined by a costing model or market output; the minimization of carbon emissions; specific commitments to subscribers, consumers 120, or energy tariffs; business rules; and other regulator requirements.

As an example, consider the following constraint governing G generators 118 (G₁-G_{N}) and S subscribers of energy (S₁-S_{N}), wherein energy units are derived and allocated every hour: the total amount of energy generation for a given hour to be allocated to a given subscriber cannot exceed that subscriber's consumption for the hour. In this example, there would then be a number of constraints proportional to the number of generators 118 and subscribers, or 30 (days)×24 (hours/day)×G (generators)×S (subscribers) constraints. Energy generation can be expressed as a discrete quanta (such as a kilowatt hour or a megawatt hour) or as a percentage of load measured over a given time, such as an allocation period, such as an hour, day, week, month, or year. There may be additional constraints related to the amount of energy units committed to a subscriber in advance of energy generation.

Other examples of constraints can include, but are not limited to: that the total amount of energy units allocated for a given allocation period cannot exceed the total amount of energy generated during the allocation period; and that each subscriber must receive, and be matched with, at least its committed percentage of energy.

In another implementation, the system 100 can calculate, via the allocation engine 108, a set of target constraints (future constraints) fulfilled by a future distribution of energy units based on the future allocation costs of the future energy units to future energy tariffs and the set of future consumption quanta for the future allocation period.

In one implementation, the controller 104 of the system 100 is configured to derive the set of constraints based on the set of energy tariffs 114, wherein each energy tariff in the set of energy tariffs 114 defines a set of constraints including at least an eligibility interval. In this implementation, the eligibility interval specifies an interval during which an energy unit must have been generated (e.g., according to the generation timestamp of the energy unit) to be eligible for allocation to that particular tariff.

In another implementation, the set of energy attributes of each energy unit can include a generation location, and the set of constraints can include an eligible generation area. The set of eligible energy units that fulfill the set of constraints is thus characterized by a generation location located within the eligible generation area.

In yet another implementation, the set of energy attributes can further include an energy type and a generation location, while the set of constraints specified by the energy tariffs includes the energy type and generation location necessary to fulfill each tariff. Therefore, the set of energy units 112 eligible to be allocated to the set of energy tariffs 114 is characterized by attributes including: the energy type matching the energy type of the set of constraints; and the generation location matching the generation location of the set of constraints.

However, the set of constraints can include any other constraint not mentioned herein, and the controller 104 of the system 100 is configured to determine eligible units that fulfill the set of constraints for each energy tariff.

### 5.7. Calculate Energy Unit Distribution

Generally, as shown in FIGS. 2 and 3B, the system 100 is further configured to: identify a set of eligible energy units based on the set of constraints in Step S112; and calculate a distribution of the set of eligible energy units to the set of energy tariffs 114 in Step S114. More specifically, the controller 104 of the system 100 can: identify a set of eligible energy units within the energy unit inventory 106 based on the set of constraints, wherein each eligible energy unit in the set of eligible energy units is characterized by a generation timestamp within the eligibility interval; and calculate a distribution of energy units in the set of eligible energy units to the set of energy tariffs 114 that fulfill the set of constraints of each energy tariff by minimizing a total cost of the distribution, based on the cost function 110.

Generally, the controller 104 is configured to identify a set of eligible energy units based on the set of constraints. The set of constraints can be based on the cost of allocating an energy unit to an energy tariff, the set of generation quanta, the set of consumption quanta, and the energy tariff associations for the allocation period. The set of constraints, taken in aggregate, bounds the set of feasible solutions of energy unit allocations that are possible. The controller 104 is configured to search the energy unit inventory 106 to determine the eligible set of energy units 112 for each allocation action. Then, the allocation engine 108 (e.g., of the controller 104) is configured to calculate energy unit distributions that satisfy the constraints for allocation periods on the order of an hour, day, week, month, or fraction of a year, offering a quicker and more dynamic method of energy unit allocation when compared to the state of the art. By continuously running the allocation engine 108 over shorter allocation periods than those employed under traditional energy unit or energy certificate programs, the system 100 can more efficiently respond to periodic and constant changes in energy consumption and energy generation conditions and variable or volatile market forces.

The system 100 calculates the distribution of energy units to the set of energy tariffs 114 by solving for the maximum or minimum of at least one objective function subject to the set of constraints. The system, via the allocation engine 108 or the controller 104, solves for said maximum or minimum solution via linear programming, linear optimization methods, algorithms, or other suitable means. Any set of objective functions defines the relationship between energy tariffs and energy units based on the cost of allocating the energy units to the energy tariffs. The set of constraints may further define relationships between energy tariffs and energy units or may define limits or requirements related to energy unit attributes. Some constraints will apply to the allocations to individual energy tariffs, while other constraints may apply to a subset of the set of allocations. Ultimately, the set of constraints must not be mutually exclusive in how the constraints mandate rules for allocation.

The following are examples of how the allocation engine 108 can calculate an ideal distribution of energy units on the time scale of an allocation period:

In an exemplary implementation, given a set of energy units 112 E₁ . . . Eₙ generated during allocation period t, the total number of energy units can be expressed as E_{U}={E₁+E₂+ . . . E_{N}}, the total allocation of energy units associated with Subscribers S can be expressed as S_{U}=S₁Eₙ₁+S₂Eₙ₂+ . . . S_{N}E_{nN}} and the cost of energy units can be expressed as E_{C}={c₁E₁+c₂E₂+ . . . c_{N}E_{N}}. An objective function could require that all energy tariffs S be allocated a maximum number of energy units E. A set of constraints can include, for instance, that each energy tariff receives at least one energy unit (S_{N}Eₙ>0) and that the total costs E_{C} can not exceed a maximum amount of carbon emissions K (E_{C}<K). Then the allocation engine 108 calculates the maximum solution of an allocation objective function f:

fₒ(E)=S₁Eₙ₁+S₂Eₙ₂+ . . . S_{N}E_{nN}
while subject to S_{N}Eₙ>0 and E_{C}<K.

In another implementation, the penalty for failing to fulfill an energy tariff can be expressed as P(S), where P(S_{N})=0 if energy tariff N is fulfilled, P(S_{N})=1 if energy tariff N is not fulfilled (i.e. energy tariff N receives no energy units in the calculated allocation), or P(S_{N})=p/1 where p is the fractional proportion of energy units allocated compared to a baseline expectation or obligation. Penalty P(S_{N}) may also be dependent on metadata associated with the energy tariff, such as whether the energy tariff is a consumer on the grid network 116 or is a non-consumer. A set of constraints can include, for instance, that energy tariffs of consumers 120 S_{Con} are allocated a number of energy units equal to an amount of renewable energy generation quanta G_{R} produced during the allocation period t (S_{Con}Eₙ=G_{R}(t)), and that each non-consumer S_{Non} receives at least one energy unit (S_{Non}Eₙ>0) but not more than those received by consumers 120. Then the allocation engine 108 calculates the minimum solution of an allocation objective function fₒ:

fₒ(S_{1,} S_{2, . . .} Sₙ)=P(Sₙ)+(S_{Non1}Eₙ₁+S_{Con1}Eₙ₂+ . . . S_{N}E_{nN}),
and subject to S_{Non}Eₙ>0 and S_{Con}Eₙ=G_{R}(t).

Linear programming methods for arriving at valid solutions to optimal energy unit allocation are not limited to the illustrative methodologies discussed herein but may incorporate or include additional algorithmic methods and other examples.

### 5.8. Update Allocation Database and Energy Unit Inventory

In one implementation, and as shown in FIGS. 2 and 3A, the system 100 is further configured to update an allocation database and/or an energy unit inventory 106 to reflect which energy units have been allocated to which energy tariffs. During the method, the controller 104 is configured to store each energy unit it calculates in an energy unit inventory 106 in Step S106. The controller 104 can store each energy unit with a set of energy unit attributes (e.g., generation location, renewable energy type, generation timestamp) and an allocation status. When the controller 104 first generates the energy unit and stores it in the energy unit inventory 106, the controller 104 sets the allocation status of the newly generated energy unit to an available allocation status, indicating that the energy unit is available for allocation to an energy tariff. In one implementation, in response to executing an allocation action and allocating an energy unit to an energy tariff, the controller 104 can access the energy unit inventory 106 and update the allocation status of the energy unit from an available status to an allocated status that indicates the energy unit has been allocated to an energy tariff. In one implementation, the controller 104 can also update the energy unit inventory 106 in response to retiring one or more energy units to a registry. After an energy unit is retired to a registry, the controller 104 can update the allocations status of the energy unit to a retired allocation status, indicating that the energy unit is no longer available for allocation to energy tariffs.

### 5.9. Re-Allocation

In one implementation, the method S100 includes steps for re-running an allocation action to distribute a different set of energy units 112 to the set of energy tariffs 114. For example, during a first allocation action, executed at a first time, a first set of energy units 112 from the energy unit inventory 106 are allocated to the set of energy tariffs 114. At a later time, the system 100 can determine that the energy units in the energy unit inventory 106 are now more optimal for allocation to the set of energy tariffs 114 than the first set of energy tariffs 114. As a result, the system 100 can execute Steps of the method to re-allocate energy units to the set of energy tariffs 114 to further minimize the cost of the distribution.

The controller 104 supports retroactive re-optimization of allocations by enabling selective rollback and/or reallocation of unsettled or preliminarily settled records when new energy units are acquired, or allocation conditions change, without altering retired records. More specifically, the controller can selectively revert allocation state metadata (e.g., change the allocation status of an energy unit from “settled” to “available”) for non-retired energy units and re-execute an allocation action to a particular energy tariff while enforcing immutability constraints on retired energy units to prevent duplication or double-counting. Therefore, the system 100 can selectively unsettle and re-settle allocations of energy units to energy tariffs in order to optimize future allocations.

In one implementation, each energy unit includes a set of energy unit attributes, and the set of energy unit attributes includes an allocation status. The controller 104 can store the set of energy units 112 in an energy unit inventory 106 by storing each energy unit with an available allocation status. Then, during an allocation action, the controller 104 can search the energy unit inventory 106 for a set of eligible energy units, wherein each eligible energy unit in the set of eligible energy units is characterized by the available allocation status or a settled allocation status. For example, if the energy unit has a settled allocation status, that energy unit is currently allocated to an energy tariff, but the controller 104 can un-allocate that energy unit from the energy tariff and choose to allocate it to a different energy unit.

In one implementation, the method can further include, during a second allocation action occurring after the first allocation action, allocating energy units from the energy unit inventory 106 to the set of energy tariffs 114 by: identifying a second set of eligible energy units within the energy unit inventory 106, each eligible energy unit in the second set of eligible energy units characterized by an age less than or equal to the maximum age of the set of constraints and an available or settled allocation status; calculating a second distribution of energy units in the second set of eligible energy units to the set of energy tariffs 114 that fulfills the set of constraints by minimizing the total cost of the second distributed, based on the cost function 110; and updating the energy unit inventory 106. The controller 104 can update the energy unit inventory 106 by: changing the allocation status of each energy unit in the first set of eligible energy units distributed to the set of energy tariffs 114 to the available allocation status; and changing the allocation status of each energy unit in the second set of eligible energy units distributed to the set of energy tariffs 114 to an unavailable allocation status. As a result, any energy unit that was unallocated (e.g., removed from allocation to an energy tariff) is set back to an available allocation status by the controller 104, and any energy unit that was allocated to the energy during a later allocation action (e.g., the second allocation action) is updated by the controller 104 to a settled allocation status. In one implementation, if the allocation action is a final allocation to fulfill the energy tariff, the controller 104 can update the energy unit inventory 106 to change all allocation statuses of energy units involved in the final allocation to an unavailable allocation status or a retired allocation status.

### 5.10. Predict Energy Usage and Demand

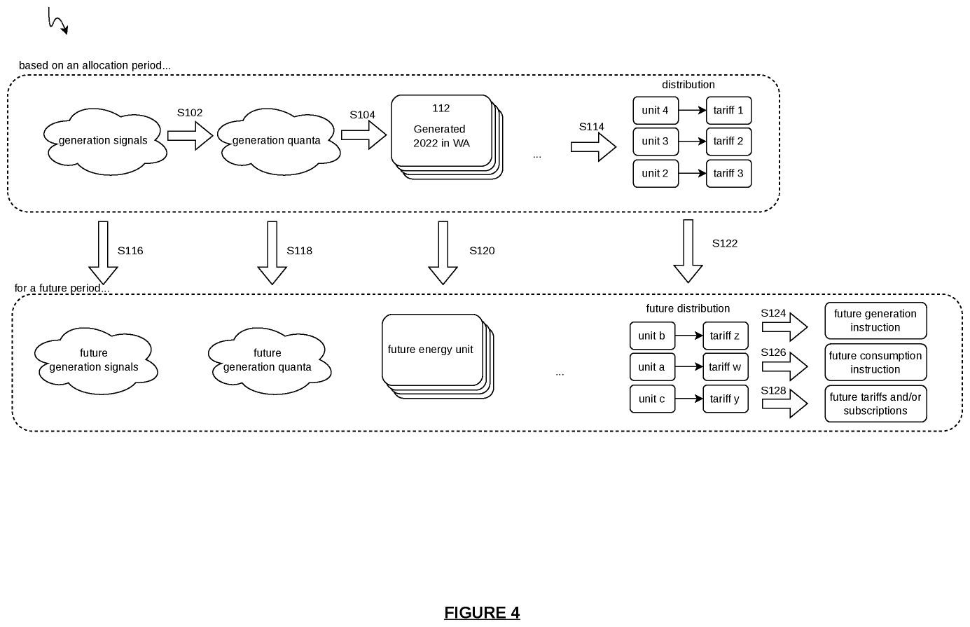

In one implementation, as shown in FIG. 4, the system 100 is configured to predict generation quanta or consumption quanta based on grid network 116 conditions, including but not limited to trends in generation and consumption. The system 100 can predict generation quanta or consumption quanta that would result in a distribution of energy units that fulfills the set of constraints over a future allocation period. Predicted sets of generation quanta or consumption quanta may be calculated by the controller 104. Once target quanta of either or both types are calculated, the system 100 can further transmit instructions to the set of generators 118 to generate an amount of energy equal to the amount included in the target generation quanta and/or transmit instructions to the set of consumers 120 to consume an amount of energy equal to the amount included in the target consumption quanta.

In one implementation, the system 100 can predict a set of future signals. The system 100 can predict a future set of generation signals based on the present set of generation signals in Step S116. The system 100 can predict a future set of consumption signals based on the present set of consumption signals. Sets of signals may be predicted through calculation, modeling, extrapolation, or other suitable means. Predicted sets of signals may be generated by the controller 104. Predicted sets of signals may also be based on exogenous factors, such as weather forecasts and historical generation data, historical consumption data, and data trends. The system 100 can be further configured, once future sets of signals are predicted, to calculate the set of generation quanta for the allocation period based on the set of generation signals and the set of future generation signals, and/or the set of consumption quanta for the allocation period based on the set of consumption signals and the set of future consumption signals. The system 100 can calculate the set of consumption quanta and/or the set of generation quanta for the allocation period based on the respective set of consumption signals and generation signals, and the set of future consumption signals.

In one implementation, as shown in FIG. 4, the controller 104 is further configured to derive a set of future generation instructions for a generator based on predictions. More specifically, the controller 104 can: predict future consumption quanta for a future period based on the consumption quanta for the allocation period; predict future generation quanta for the future period based on the generation quanta for the allocation period in Step S118; predict a set of future energy tariffs based on the set of energy tariffs 114; and calculate a set of future energy units based on the future generation quanta in Step S120. Then, the controller 104 can simulate a future allocation action and calculate a future distribution of energy units from a predicted energy unit inventory 106 to the set of predicted energy tariffs to fulfill a set of constraints associated with the set of predicted energy tariffs, wherein the predicted energy unit inventory 106 includes each energy unit in the energy unit inventory 106 and the set of future energy units in Step S122. In response to an unfulfilled energy tariff, the controller 104 can: derive a set of future generation instructions for the future period; and transmit the set of future generation instructions to the set of generators 118 in Step S124. Therefore, the system 100 is configured to derive a target future generation of renewable energy based on predicted generation, consumption, and allocations, wherein the target future generation is configured to prevent unfilled future energy tariffs.

In one implementation, the system 100 can instruct generators 118 to generate a target amount of energy or generate energy according to a target schedule. For example, the controller 104 can: predict a set of target generation quanta resulting in a target distribution of energy units that fulfills the set of constraints over a future allocation period; and transmit instructions to the set of generators 118 to generate the set of target generation quanta.

The system 100 can similarly generate target consumption amounts or a target consumption schedule to inform consumers 120 of the grid network 116. For example, the system 100 can: predict a set of target consumption quanta resulting in a target distribution of energy units that fulfills the set of constraints over a future allocation period; and transmit instructions to the set of consumers 120 to consume the set of target consumption quanta in Step S126. As a result, the system 100 enables a grid operator and/or utility to inform the consumption of energy to improve the allocation of energy units for a future period.

In another implementation, the system 100 can determine a set of voluntary subscriptions for the grid operator and/or utility to issue for a future period. The system 100 can calculate the set of subscriptions based on trends of energy generation and consumption and thereby predict a set of fulfillable subscriptions for the future period. More specifically, the method can include: predicting future generation quanta for a future period based on the generation quanta from the allocation period; predicting a set of future consumption signals for the future period based on a consumption quanta from the allocation period; calculating a set of future energy units corresponding to the set of future generation quanta for the future period; calculating a set of target constraints fulfilled by a future distribution of energy units to energy tariffs based on the cost function 110 and the set of future consumption quanta for the future allocation period; deriving a set of target subscriptions from the set of target constraints; and transmitting the set of target subscriptions to the set of consumers 120. As a result, the grid operator can issue subscriptions to a set of consumers 120 that the system 100 has predicted the operator will be able to fulfill in a future period in Step S128.

In another implementation, the system 100 can predict whether a set of future voluntary subscriptions is fulfillable during a future period. In response to predicting an unfulfillable subscription, the system 100 can generate a set of subscriptions and terms of those subscriptions that enable a higher likelihood of fulfillability. For example, the system 100 can execute steps including: predicting future consumption quanta for a future period based on the consumption quanta for the allocation period; predicting future generation quanta for the future period based on the generation quanta for the allocation period; predicting a set of future energy tariffs based on the set of energy tariffs 114; and calculating a set of future energy units based on the future generation quanta. The system 100 can then: calculate a future distribution of energy units from a predicted energy unit inventory 106 to the set of predicted energy tariffs to fulfill a set of constraints associated with the set of predicted energy tariffs, wherein the predicted energy unit inventory 106 includes each energy unit in the energy unit inventory 106 and the set of future energy units; in response to an unfulfilled energy tariff based on the consumption quanta for the allocation period, derive a set of fulfillable energy tariffs for the future period; and transmit the set of fulfillable energy tariffs for the future period to the set of consumers 120. As a result, the system 100 can enable operators to issue subscriptions with terms that the system 100 predicts are fulfillable based on consumption and generation trends, thereby reducing the risk of future unfulfilled subscriptions.

### 5.11. Transmit Instructions

In another implementation, the system 100 can also be configured to transmit instructions to the set of generators 118 and/or to the set of consumers 120. The instructions may include directives to consume, or refrain from consuming, a certain amount of energy within an allocation period or to generate, or refrain from generating, a certain amount of energy within an allocation period.

### 5.12. Transfer Energy Units

In another implementation, the system 100 can be further configured to transfer energy units to at least one subscriber in the set of subscribers. While energy units are calculated and associated via the controller 104 and allocated via the allocation engine 108, the system 100 can be further configured to send energy units in a fungible form directly to a subscriber associated with a subscription (e.g., a voluntary energy tariff).

### 5.13. Retire Energy Units to Registry

In one implementation, the system 100 is configured to communicate with one or more official registries that track retirement of energy units. For example, the system 100 can retire energy units to registries including the North American Registry (NAR), Western Renewable Energy Generation Information System (WREGIS), Midwest Renewable Energy Tracking System (M-RETs), or any other energy unit registry. In one implementation, after the system 100 has executed the method to allocate an energy unit to an energy tariff, the system 100 can report the allocation of the particular energy unit to the particular energy tariff to the registry. For example, the system 100 can execute steps to access and interface with an API of a registry and report retired energy units to the registry via the API.

In one implementation, the method may include allocation of fractions of energy units to fulfill energy tariffs, and energy unit registries may not accept reports of fractional energy units. In this case, the system 100 can keep track of the energy unit (e.g., via the energy unit inventory 106) including which tariff each fraction of the energy unit is allocated to, and only retire the full energy unit to a registry when the entirety of the unit (e.g., portions of the energy unit adding up to 100%) has been allocated.

We claim:

1. A system for dynamically allocating energy units between a set of generators and a set of consumers in a grid network, the system comprising:
a set of grid monitoring devices distributed in the grid network configured to receive:
a set of generation signals associated with the set of generators during an allocation period; and
a set of consumption signals associated with the set of consumers during the allocation period;
a controller configured to:
calculate generation quanta for the allocation period based on the set of generation signals;
calculate consumption quanta for the allocation period based on the set of consumption signals;
calculate a set of energy units based on the generation quanta, each energy unit in the set of energy units characterized by a set of energy unit attributes comprising a generation timestamp;
store the set of energy units in an energy unit inventory;
access a cost function configured to calculate a cost of allocating an energy unit in the energy unit inventory to an energy tariff based on:
the set of energy unit attributes comprising the generation timestamp; and
a set of energy tariff attributes comprising an eligibility interval of generation timestamps;
for a first allocation action, allocate energy units from the energy unit inventory to a set of energy tariffs by:
deriving a set of constraints based on the set of energy tariffs wherein each energy tariff in the set of energy tariffs defines a set of constraints comprising at least the eligibility interval;
identifying a first set of eligible energy units within the energy unit inventory based on the set of constraints, wherein each eligible energy unit in the set of eligible energy units is characterized by a generation timestamp within the eligibility interval; and
calculating a distribution of energy units in the first set of eligible energy units to the set of energy tariffs that fulfill the set of constraints of each energy tariff in the set of energy tariffs by minimizing a total cost of the distribution, based on the cost function.

2. The system of claim 1, wherein the controller is further configured to:
predict future consumption quanta for a future period based on the consumption quanta for the allocation period;
predict future generation quanta for the future period based on the generation quanta for the allocation period;
predict a set of future energy tariffs based on the set of energy tariffs;
calculate a set of future energy units based on the future generation quanta;
during a future allocation action, calculate a future distribution of energy units from a predicted energy unit inventory to the set of predicted energy tariffs to fulfill a set of constraints associated with the set of predicted energy tariffs, wherein the predicted energy unit inventory comprises each energy unit in the energy unit inventory and the set of future energy units;
in response to an unfulfilled energy tariff, derive a set of future generation instructions for the future period; and
transmit the set of future generation instructions to the set of generators.

3. The system of claim 1, wherein the controller is further configured to:
predict a set of target generation quanta resulting in a target distribution of energy units that fulfills the set of constraints over a future allocation period; and
transmit instructions to the set of generators to generate the set of target generation quanta.

4. A method for dynamically allocating energy units between a set of generators and a set of consumers in a grid network comprising:
accessing generation quanta for an allocation period based on a quantized total of energy generation during the allocation period;
calculating a set of energy units based on the generation quanta, each energy unit in the set of energy units characterized by a set of energy unit attributes comprising a generation timestamp;
storing the set of energy units in an energy unit inventory;
accessing a cost function configured to calculate a cost of allocation of an energy unit to an energy tariff based on:
the set of energy unit attributes comprising a generation timestamp; and
a set of energy tariff attributes comprising an eligibility interval of generation timestamps;
during a first allocation action, allocating energy units from the energy unit inventory to a set of energy tariffs by:
deriving a set of constraints based on the set of energy tariffs wherein each energy tariff in the set of energy tariffs defines a set of constraints comprising at least the eligibility interval;
identifying a first set of eligible energy units within the energy unit inventory based on the set of constraints, wherein each eligible energy unit in the set of eligible energy units is characterized by a generation timestamp within the eligibility interval; and
calculating a distribution of energy units in the first set of eligible energy units to the set of energy tariffs that fulfill the set of constraints of each energy tariff in the set of energy tariffs by minimizing a total cost of the distribution, based on the cost function.

5. The method of claim 4:
wherein the set of energy tariffs comprises a set of voluntary subscriptions and a set of regulatory requirements;
further comprising:
accessing consumption quanta for the allocation period based on a quantized total of energy consumption during the allocation period;
for each voluntary subscription in the set of voluntary subscriptions, determining an amount of energy consumed by a consumer associated with the voluntary subscription based on the consumption quanta; and
wherein calculating the distribution of energy units to the set of energy tariffs comprises allocating a number of energy units to each voluntary subscription proportional to the amount of energy consumed by the consumer associated with the voluntary subscription.

6. The method of claim 4, wherein:
the cost function assigns:
a first cost to allocate a first energy unit to the energy tariff, wherein the first energy unit is characterized by a first generation timestamp within the eligibility interval; and
a second cost, less than the first cost, to allocate a second energy unit to the energy tariff, wherein the second energy unit is characterized by a second generation timestamp within the eligibility interval and preceding the first generation timestamp; and
calculating the distribution of energy units in the first set of eligible energy units to the energy tariff by minimizing the total cost of the distribution comprises allocating the second energy unit to the energy tariff.

7. The method of claim 4, wherein:
the set of energy unit attributes further comprises an energy type and a generation location
the set of constraints further comprises the energy type and the generation location; and
the first set of eligible energy units is characterized by energy unit attributes comprising:
the energy type matching the energy type of the set of constraints; and
the generation location matching the generation location of the set of constraints.

8. The method of claim 4, wherein:
the set of energy unit attributes further comprises a generation location;
the set of constraints further comprises an eligible generation area; and
the first set of eligible energy units is characterized by the generation location located within the eligible generation area.

9. The method of claim 8, wherein:
the eligible generation area is characterized by a generation area locus;
the cost function assigns:
a first cost to allocate a first energy unit to the energy tariff, wherein the first energy unit is characterized by a first generation location, a first distance from the generation area locus of the eligible generation area; and
a second cost, less than the first cost, to allocate a second energy unit to the energy tariff, wherein the second energy unit is characterized by a second distance, less than the first distance, from the generation area locus of the eligible generation area; and
calculating the distribution of energy units in the first set of eligible energy units to the energy tariff by minimizing the total cost of the distribution comprises allocating the second energy unit to the energy tariff.

10. The method of claim 4:
wherein:
the set of energy unit attributes further comprises an allocation status;
storing the set of energy units in an energy unit inventory comprises storing each energy unit in the set of energy units with an available allocation status; and
wherein each eligible energy unit in the set of eligible energy units is further characterized by the available allocation status or a settled allocation status; and
further comprising updating the energy unit inventory by changing the allocation statuses of the energy units in the first set of eligible energy units distributed to the set of energy tariffs to the settled allocation status.

11. The method of claim 10, further comprising, during a second allocation action occurring after the first allocation action, allocating energy units from the energy unit inventory to the set of energy tariffs by:
identifying a second set of eligible energy units within the energy unit inventory, each eligible energy unit in the second set of eligible energy units characterized by:
an age less than or equal to the maximum age of the set of constraints;
an available or settled allocation status;
calculating a second distribution of energy units in the second set of eligible energy units to the set of energy tariffs that fulfill the set of constraints by minimizing the total cost of the second distribution, based on the cost function; and
updating the energy unit inventory by:
changing the allocation status of each energy unit in the first set of eligible energy units distributed to the set of energy tariffs to the available allocation status; and
changing the allocation status of each energy unit in the second set of eligible energy units distributed to the set of energy tariffs to an unavailable allocation status.

12. The method of claim 4, wherein:
the set of energy tariff attributes further comprises a tariff classification indicating whether an energy tariff in the set of energy tariffs is a voluntary subscription or a regulatory requirement;
the cost function assigns:
a first cost to allocate a first energy unit to the voluntary subscription; and
a second cost, less than the first cost, to allocate the first energy unit to the regulatory requirement; and
calculating the distribution of energy units in the first set of eligible energy units to the energy tariff by minimizing the total cost of the distribution comprises allocating the first energy unit to the second energy tariff.

13. The method of claim 4, wherein:
the set of energy tariff attributes further comprises a tariff fulfillment deadline indicating a date and/or time by which energy units must be distributed to an energy tariff in the set of energy tariffs to fulfill the energy tariff;
the cost function is configured to calculate the cost of allocation of an energy unit to an energy tariff, further based on a set of current conditions comprising a current time and date;
the cost function assigns:
a first cost to allocate a first energy unit to a first energy tariff characterized by a first tariff fulfillment deadline; and
a second cost, less than the first cost, to allocate the first energy unit to the second energy tariff characterized by a second tariff fulfillment deadline preceding the first tariff fulfillment deadline of the first energy tariff; and
calculating the distribution of energy units in the first set of eligible energy units to the energy tariff by minimizing the total cost of the distribution comprises allocating the first energy unit to the second energy tariff.

14. The method of claim 4, wherein:
the set of energy tariff attributes further comprises a tariff value of each energy tariff in the set of energy tariffs;
the cost function assigns:
a first cost to allocate a first energy unit to a first energy tariff characterized by a first tariff tariff value; and
a second cost, less than the first cost, to allocate the first energy unit to a second energy tariff characterized by a second tariff value greater than the first tariff value; and
calculating the distribution of energy units in the first set of eligible energy units to the energy tariff by minimizing the total cost of the distribution comprises allocating the first energy unit to the second energy tariff.

15. The method of claim 4, wherein:
the cost function is further configured to:
for each energy tariff in the set of energy tariffs, calculate a fulfillability factor for each energy tariff based on the set of constraints derived from the energy tariff and the set of energy tariffs, wherein a high fulfillability factor indicates relative ease of fulfillment of the energy tariff compared to a low fulfillability factor;
for each energy unit in the set of energy units, calculate an applicability factor based on the set of energy unit attributes of the energy unit and the energy unit inventory, wherein a high applicability factor indicates relative ease of allocation to an energy tariff compared to a low applicability factor;
the cost function assigns:
a first cost to allocating a first energy unit characterized by a high applicability factor to a first energy tariff characterized by a high fulfillability factor; and
a second cost, less than the first cost, to allocate the first energy unit to a second energy tariff characterized by a low fulfillability factor; and
calculating the distribution of energy units in the first set of eligible energy units to the energy tariff by minimizing the total cost of the distribution comprises allocating the first energy unit to the second energy tariff.

16. The method of claim 4, further comprising:
predicting future generation quanta for a future period based on the generation quanta from the allocation period;
predicting a set of future consumption signals for the future period based on a consumption quanta from the allocation period;
calculating a set of future energy units corresponding to the set of future generation quanta for the future period;
calculating a set of target constraints fulfilled by a future distribution of energy units to energy tariffs based on the cost function and the set of future consumption quanta for the future allocation period;
deriving a set of target subscriptions from the set of target constraints; and
transmitting the set of target subscriptions to the set of consumers.

17. The method of claim 4, further comprising:
predicting future consumption quanta for a future period based on the consumption quanta for the allocation period;
predicting future generation quanta for the future period based on the generation quanta for the allocation period;
predicting a set of future energy tariffs based on the set of energy tariffs;
calculating a set of future energy units based on the future generation quanta;
during a future allocation action, calculating a future distribution of energy units from a predicted energy unit inventory to the set of predicted energy tariffs to fulfill a set of constraints associated with the set of predicted energy tariffs, wherein the predicted energy unit inventory comprises each energy unit in the energy unit inventory and the set of future energy units;
in response to an unfulfilled energy tariff based on the consumption quanta for the allocation period, deriving a set of fulfillable energy tariffs for the future period; and
transmitting the set of fulfillable energy tariffs for the future period to the set of consumers.

18. The method of claim 4, further comprising:
predicting a set of target generation quanta resulting in a target distribution of energy units that fulfills the set of constraints over a future allocation period; and
transmitting instructions to the set of generators to generate the set of target generation quanta.

19. The method of claim 4, further comprising:
predicting a set of target consumption quanta resulting in a target distribution of energy units that fulfills the set of constraints over a future allocation period; and
transmitting instructions to the set of consumers to consume the set of target consumption quanta.

20. The method of claim 4:
wherein the allocation period is one hour; and
further comprising a set of allocation actions, comprising the first allocation action, characterized by an hourly allocation frequency.
